(19) United States
(12) Patent Application Publication
(10) Pub. No.: US 2004/0141628 A1
(43) Pub. Date: Jul. 22, 2004

(54) Earpiece with interchangeable end portion

(75) Inventors: Marcial Villaverde, Mt. Prospect, IL (US); Tai Hoon Matlin, Round Lake Beach, IL (US)

Correspondence Address: PILLSBURY WINTHROP, LLP, P.O. BOX 10500, MCLEAN, VA, 22102, US

(73) Assignee: FELLOWES, INC., Itasca, IL (US)

(21) Appl. No.: 10/346,206

(22) Filed: Jan. 17, 2003

(51) Int. Cl. H04R 25/00

(52) U.S. Cl. 381/381; 381/374; 381/375

(57) ABSTRACT

One aspect of the invention provides an earpiece having an interchangeable end portion. Another aspect of the invention provides a method for replacing part of an earpiece.

### FIELD OF THE INVENTION

The present invention relates to an earpiece for supporting a speaker that connects to an electronic device, such as a wireless telephone, a portable radio, a hearing aid device, or any other type of electronic device.

### BACKGROUND OF THE INVENTION

Generally, earpieces are worn on a wearer's ear to support a speaker proximate the ear. Such devices usually include an ear hook that fits over the user's ear. This ear hook may be adjustable in a flexing manner to permit a comfortable fit over the user's ear.

The present invention relates to improvements over these earpieces.

### SUMMARY OF THE INVENTION

One aspect of the invention provides an earpiece having an interchangeable end portion. The earpiece of this aspect of the invention comprises an elongated ear hook configured to be mounted over a user's ear. The ear hook comprises a speaker mounting portion and an interchangeable end portion extending away from the speaker mounting portion. A speaker is mounted on the speaker mounting portion and is adapted to generate audible signals based on electric signals received from an electronic device. The interchangeable end portion is releasably mounted on the speaker mounting portion so as to enable the interchangeable end portion to be separated from the speaker mounting portion and replaced with another interchangeable end portion.

By enabling the interchangeable end portion to be separated from the main speaker mounting portion and replaced with another interchangeable end portion, the user can replace the existing end portion with another one having a different appearance and/or configuration. This is desirable for allowing a wearer to change the earpiece's appearance to match with clothing colors or fashion accessories. Alternatively, this feature allows for easy replacement of the end portion in the event it becomes damaged. As another option, this feature could be used to allow a wearer having particularly large or small ears to replace the existing end portion with an end portion of better-suited size for purposes of fitting the wearer's ear.

A related aspect of the invention comprises a method for replacing part of an earpiece. The earpiece comprises an elongated ear hook configured to be mounted over a user's ear. The ear hook comprises a speaker mounting portion and an interchangeable end portion extending away from the speaker mounting portion. The interchangeable end portion is releasably mounted to the speaker mounting portion so as to enable the interchangeable end portion to be separated from the speaker mounting portion. A speaker is mounted on the speaker mounting portion and is adapted to generate audible signals based on electric signals received from an electronic device. The method comprises (a) separating the interchangeable end portion from the speaker mounting portion; (b) selecting a replacement interchangeable end portion; and (c) releasably mounting the replacement interchangeable end portion to the speaker mounting portion.

Another aspect of the invention provides an earpiece having a feature for better management of a wire coupled to the speaker of the earpiece. The earpiece of this aspect of the invention comprises an elongated ear hook configured to be mounted over a user's ear. A speaker is mounted to the ear hook and is adapted to generate audible signals based on electrical signals received from an electronic device, and a wire is connected to the speaker for electrically coupling the speaker to the electronic device. The ear hook has an elongated slot along a portion thereof. The slot is configured to releasably retain the wire therein so as to support the wire on the ear hook.

This slot functions to keep the wire in position on the earpiece. Also, if the wire is tugged or pulled, the structure defining the slot can absorb or take-up some of that tugging or pulling force. This minimizes or eliminates force being applied to the juncture of the wire with the speaker or other point of connection.

Other objects, features and advantages of the present invention will become apparent from the following detailed description, the accompanying drawings, and the appended claims.

### BRIEF DESCRIPTION OF THE DRAWINGS

FIG. 1 is a profile view of an earpiece constructed in accordance with the present invention;

FIG. 2 is a close-up view of the earpiece of FIG. 1;

FIG. 3 is a cross-sectional view taken along line 3-3 in FIG. 4; and

FIG. 4 illustrates the method of making an interchangeable end portion and assembling the same into the earpiece of FIG. 1.

FIG. 5 is a profile view of an alternative ear hook for use in the earpiece of FIG. 1.

### DETAILED DESCRIPTION OF THE ILLUSTRATED EMBODIMENT

The Figures illustrate an exemplary embodiment of an earpiece, generally indicated at 10, constructed according to the present invention. The earpiece comprises an elongated ear hook, generally indicated at 12, configured to be mounted over a user's ear. The hook 12 has a general U-shape and in the illustrated embodiment can be bent or deformed to better fit the wearer's ear, but that is not a necessary feature. The ear hook 12 comprises speaker mounting portion 14 and an interchangeable end portion 16 extending away from the speaker mounting portion 14. As will be discussed in further detail below, the interchangeable end portion 16 is releasably mounted on the speaker mounting portion 14 so as to enable the interchangeable end portion 16 to be separated from the speaker mounting portion and replaced with another interchangeable end portion.

The earpiece 10 further includes at least a speaker, shown in phantom at 18, mounted on the speaker mounting portion 14 and adapted to generate audible signals based on electric signals received from an electronic device (not shown). The electronic device may be a wireless telephone, a portable radio, a hearing aid, or any other device to which a speaker may be connected. The connection between the speaker 18 and the electronic device may be accomplished via conventional wiring 19, or may be via a wireless connection, such as the one embodied in the well-known BLUETOOTH standard. The speaker 18 may have any suitable construction and/or configuration, and the present invention is not intended to be limited to any specific type of speaker.

In the illustrated embodiment, the earpiece 10 further comprises a boom 20 and a microphone, shown in phantom at 22, adapted to transmit electrical signals to the electronic device based on the wearer's voice, particularly airborne signals from the wearer's mouth. The speaker 18 and the microphone 22 are mounted in spaced apart relation on the boom 20 and the boom 20 is mounted to the speaker mounting portion 14. Preferably, the positioning of the speaker 18 and microphone 22 are such that the speaker 18 is immediately over the wearer's ear and the microphone 22 is positioned proximate the wearer's mouth for facilitating pick-up of the wearer's voice. Further, the boom 20 encases both the speaker 18 and the microphone 22, although that is not a necessary feature. Like the speaker 18, the connection between the microphone 22 and the electronic device may be accomplished via conventional wiring, or may be via a wireless connection, such as the one embodied in the well-known BLUETOOTH standard. The microphone 22 may have any suitable construction and/or configuration, and the present invention is not intended to be limited to any specific type of speaker. Also, as an alternative to being of the type proximate the wearer's mouth, the microphone may be a “bone” microphone that is positioned adjacent the wearer's mastoid bone so as to pick-up the wearer's voice via vibrations of the mastoid bone.

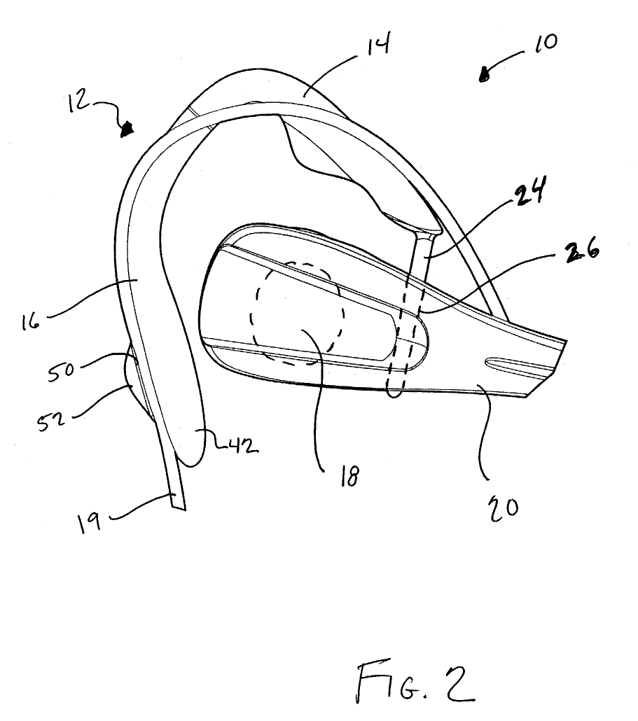

In the illustrated embodiment and best seen in FIG. 2, the speaker mounting portion 14 has a post 24 depending downwardly there from and the boom 20 has a bore 26 formed therethrough. The boom 20 is mounted to the speaker mounting portion 14 by the post 24 being received in the bore 26 thereof. Preferably, the speaker mounting portion 14 is molded from one-piece as rigid plastic so as to be the main structural element for attaching the other componentry. Optionally, the post 24 and bore 26 are configured to enable pivotal movement of the boom 20 about the post 24, which allows for adjustability in positioning the microphone 22 and speaker 18. It should be understood that any suitable construction or configuration for mounting the speaker 18 and/or the microphone 22 to the speaker mounting portion 24 may be used. Further, the speaker mounting portion 14 itself may have any suitable construction or configuration.

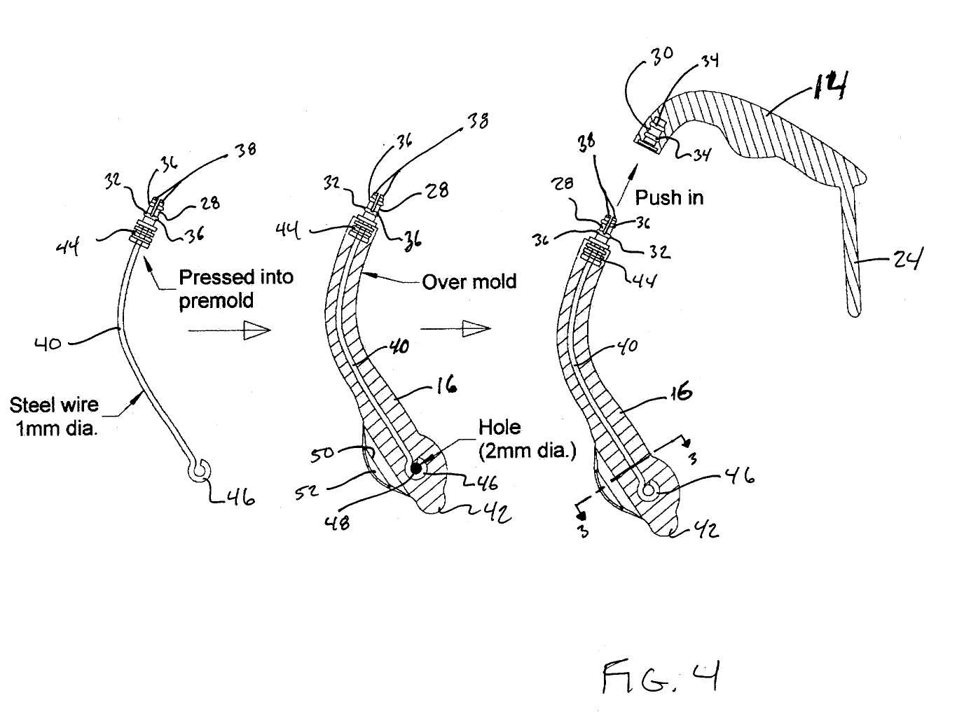

With respect to the interchangeable end portion 16, in the illustrated embodiment this end portion 16 is flexible so that it can be bent or deformed to better fit the earhook 12 to the wearer's ear. This is a preferred feature and should not be considered limiting. The distal end of the interchangeable end portion 14 includes a molded plastic snap-in connector 28 constructed to releasably mount the interchangeable end portion 16 to the speaker mounting portion 14. Specifically, the speaker mounting portion 14 includes a bore 30 and the snap-in connector 28 includes a snap-in post 32 constructed to be inserted in a snap-fit releasably locked relation into the bore 30 to releasably mount the interchangeable end portion 16 to the speaker mounting portion 14. As can be appreciated from FIG. 4, the interior of the bore 30 has two annular grooves 34 and the exterior of the post 32 has ridges 36 formed on two resilient fingers 38. The post 32 snap-fits into the bore 30 by the fingers 38 flexing inwardly to accommodate ingress of the post 32 and then resiliently flexing outward to engage the ridges 36 within the grooves 34. Upon withdrawal of the post 32 from the bore 30 the fingers 38 will flex inwardly via the camming of the ridges 36 out of the grooves 34. The particular construction illustrated for releasably mounting the interchangeable end portion 16 to the speaker mounting portion 14 is only considered to be exemplary and should not be considered limiting. To the contrary, any suitable construction for effecting releasable securement of the interchangeable end portion 16 to the speaker mounting portion 14 may be used.

In the illustrated embodiment, the interchangeable end portion 16 also includes a flexible wire 40 and a flexible material 42 molded over both the snap-in connector 28 and the wire 40 to secure them together. The wire 40 and flexible material 42 allow the end portion to be flexed to accommodate a better fit on a wearer's ear. The wire 40 provides some underlying structure to the flexible material 42 and may be a resilient or a ductile wire. A resilient wire enables the wire to resiliently flex against the wearer's ear, and a ductile wire allows the wire to maintain a configuration into which it is flexed for accommodating a conforming fit on a wearer's ear. The wire 40 is attached by pressing its upper end into a bore on the snap connector 28, placing the wire 40 and connector 28 into an injection molding die, and then injecting the flexible material 42 in molten form over the wire 40 and snap-in connector 28 and curing the same. Ribs 44 on the connector 28 allow the material 42 to form therein and provide a secure lock between the flexible material 42 and the connector 28. However, the presence of a wire or any specific characteristics thereof are not considered essential and any suitable construction or configuration may be used for the interchangeable end portion 16.

In the illustrated embodiment, the distal end of the wire 40 is bent into a loop 46. During molding, a pin 48 is placed into this loop and engages the molding die to prevent the wire end from moving as the material 42 is being injected into the die. Upon curing, this pin is pressed out, and a small hole is left. The use of this pin 48 is optional and should not be considered limiting.

The flexible material 42 has an elongated slot 50 formed therein to provide a path for retaining the wire 19 connecting the speaker 18 and/or microphone 22 to the electronic device. Specifically, this slot 50 is configured to releasably retain the wire 19 therein so as to support the wire 19 on the ear hook 12. This functions to keep the wire 19 in position on the earpiece 10. Also, if the wire is tugged or pulled, the structure defining the slot 50 can absorb or take-up some of that tugging or pulling force. This minimizes or eliminates force being applied to the juncture of the wire 19 with the speaker or its boom. As can be appreciated from the Figures, the slot 50 is defined on one side by the main body of the end portion 16 and by a wall 52 extending in spaced relation there from. The wall 52 is molded from the flexible material 42. By using a resilient material for material 42, the wall 52 can flex inwardly resiliently so as to retain the wire 19 therein in a snap-fit relation. The provision of this slot 50 is optional and should not be considered limiting. For example, any resilient material or structure can be used to releasably retain the wire in the slot and flexes to enable the wire to be removed from the slot 50.

A pod 54 is provided on the wire 19. This pod 54 is optional and includes buttons for performing functions such as volume operation and for controlling certain functions of the electronic device to which the wire 19 is connected.

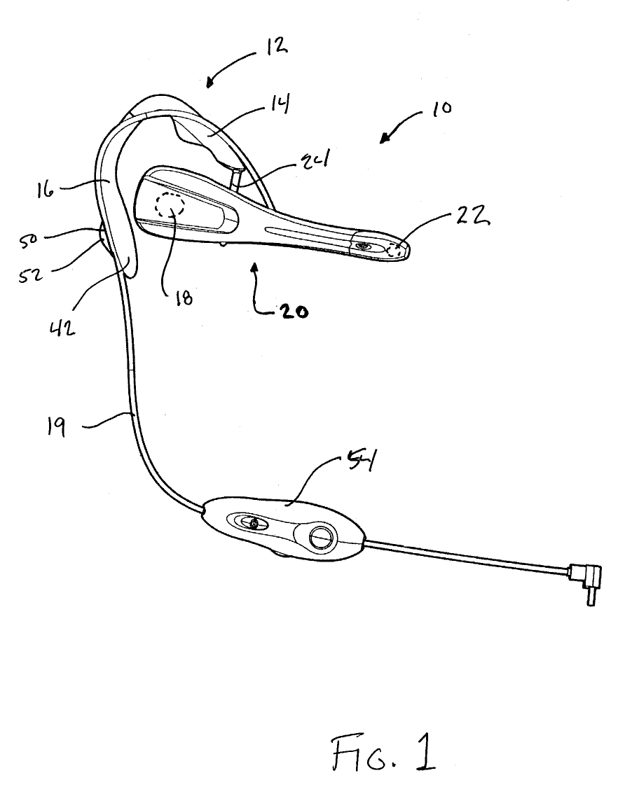

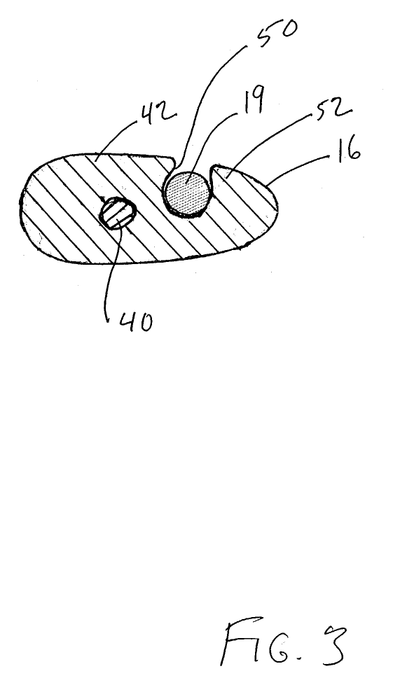

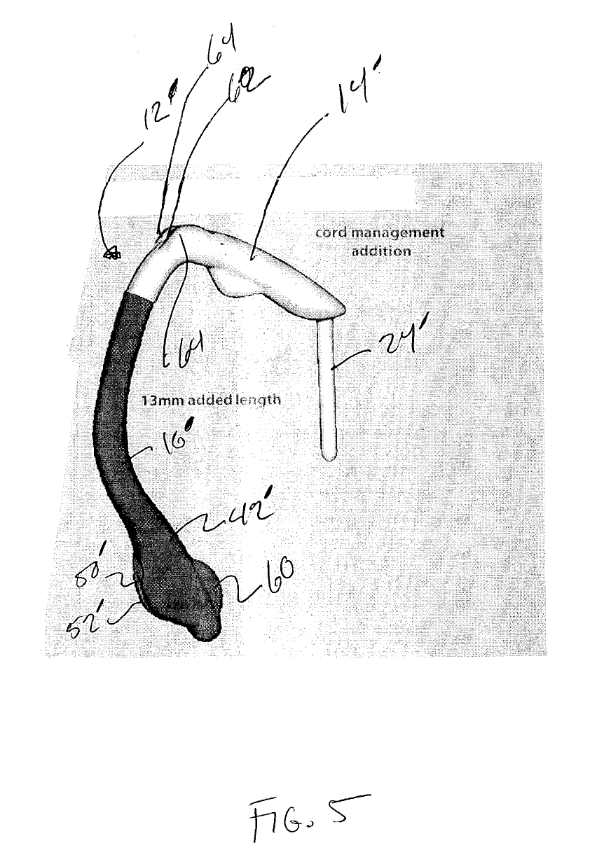

FIG. 5 illustrates an alternative ear hook 12′ that can be used in the earpiece 10 of FIGS. 1-4 in place of ear hook 12. The ear hook 12′ has the same general configuration as the ear hook 12 of FIGS. 1-4, with a few notable exceptions. The common structures between the two will be marked with similar reference numerals. First the end portion 16′ has a protrusion 60 for facilitating engagement with the user's ear. Second, the speaker mounting portion 14′ has an elongated slot 62 spaced from slot 50′. The slot 62 is defined by two protrusions 64 formed on the upper part of the speaker mounting portion 14′. The slot 62 helps to keep the wire 19 on the earpiece 10 in cooperation with slot 50′. Additionally, the positioning of the slot 62 in the uppermost part of the ear hook 12′ is preferred, as it guides the wire 19 to follow the general contour of the ear hook 12′ between the slot 50′, the slot 62, and the wires' connection to the speaker connected to the post 24′ of speaker mounting portion 14′. The slot 62 need not be located on the upper most position of the ear hook 12′, but it is preferred for enhanced wire management. Alternatively, with the slot 50′ being on the portion adjacent the lower part of the wearer's ear (as can be readily appreciated from the configuration shown in FIG. 5 taken in view of the known contour of the average human ear), the slot 62 could be positioned along any portion of the ear hook 12′ that is positioned adjacent an upper portion of the wearer's ear to facilitate guiding the wire 19 along the ear hook 12′ behind the wearer's ear. For example, it could be moved further forwardly of the position shown in FIG. 5. Further, the slot 62 could be positioned much closer to slot 50′ to serve merely as a back-up to slot 50′ in the event the wire 19 is pulled out of slot 50′. Further still, the second slot 52 could be omitted, as it is not a critical feature of the invention.

To replace the interchangeable end portion 16, the wearer separates the interchangeable end portion 16 from the speaker mounting portion 14, selects a replacement interchangeable end portion, and then releasably mounts the replacement interchangeable end portion to the speaker mounting portion 14. Generally, the replacement interchangeable end portion will have a connector with a similar interface as the original one (for example, the snap-in connector post 32) to enable it to be releasably mounted to the speaker mounting portion 14. Thus, in the illustrated embodiment, separating the interchangeable end portion 16 from the speaker mounting portion will include disengaging the snap-connector 28 thereof from the speaker mounting portion 14, and releasably mounting the replacement interchangeable end portion will include snapping the snap-in connector 28 into the speaker mounting portion 14. More specifically, in the illustrated embodiment, separating the interchangeable end portion 16 from the speaker mounting portion 14 will include withdrawing the post 32 of the interchangeable end portion's snap-in connector 28 from the bore 30, and releasably mounting the replacement interchangeable end portion will include snapping the post 32 of the replacement interchangeable end portion into the bore 30, as described above.

The foregoing illustrative embodiment has been provided solely to illustrate the structural and functional principles of the present invention and is not intended to be limiting. To the contrary, the present invention is intended to encompass all modifications, substitutions, and alterations encompassed within the spirit and scope of the following claims.

What is claimed:

1. An earpiece comprising:
an elongated ear hook configured to be mounted over a user's ear, the ear hook comprising a speaker mounting portion and an interchangeable end portion extending away from the speaker mounting portion, the interchangeable end portion being releasably mounted on the speaker mounting portion so as to enable the interchangeable end portion to be separated from the speaker mounting portion and replaced with another interchangeable end portion; and
a speaker mounted on the speaker mounting portion and being adapted to generate audible signals based on electric signals received from an electronic device.

2. An earpiece according to claim 1, further comprising a microphone adapted to transmit electrical signals to the electronic device based on the wearer's voice.

3. An earpiece according to claim 3, further comprising a boom, the speaker and the microphone being mounted in spaced apart relation on the boom and the boom being mounted to the speaker mounting portion.

4. An earpiece according to claim 3, wherein the speaker mounting portion has a post depending downwardly there from and wherein the boom has a bore formed therethrough, the boom being mounted to the speaker mounting portion by the post being received in the bore thereof.

5. An earpiece according to claim 4, wherein the post and bore are configured to enable pivotal movement of the boom about the post.

6. An earpiece according to claim 5, wherein the speaker mounting portion comprises rigid plastic.

7. An earpiece according to claim 6, wherein the boom encases both the speaker and the microphone.

8. An earpiece according to claim 1, wherein the interchangeable end portion is flexible.

9. An earpiece according to claim 8, wherein the interchangeable end portion includes a snap-in connector constructed to releasably mount the interchangeable end portion to the speaker mounting portion.

10. An earpiece according to claim 9, wherein the speaker mounting portion includes a bore and wherein the snap-in connector includes a snap-in post constructed to be inserted in a snap-fit releasably locked relation into the bore to releasably mount the interchangeable end portion to the speaker mounting portion.

11. An earpiece according to claim 10, wherein the interchangeable end portion includes a flexible wire connected to the snap-in connector and a flexible material molded over both the snap-in connector and the wire to secure them together.

12. An earpiece according to claim 11, wherein the wire is ductile.

13. A method for replacing part of an earpiece, the earpiece comprising: (a) an elongated ear hook configured to be mounted over a user's ear, the ear hook comprising a speaker mounting portion and an interchangeable end portion extending away from the speaker mounting portion, the interchangeable end portion being releasably mounted to the speaker mounting portion so as to enable the interchangeable end portion to be separated from the speaker mounting portion; and (b) a speaker mounted on the speaker mounting portion and being adapted to generate audible signals based on electric signals received from an electronic device; the method comprising:
separating the interchangeable end portion from the speaker mounting portion;
selecting a replacement interchangeable end portion; and
releasably mounting the replacement interchangeable end portion to the speaker mounting portion.

14. A method according to claim 13, wherein the interchangeable end portion and the replacement thereof each includes a snap-in connector, wherein separating the interchangeable end portion from the speaker mounting portion includes disengaging the snap-connector thereof from the speaker mounting portion, and wherein releasably mounting the replacement interchangeable end portion includes snapping the snap-in connector to the speaker mounting portion.

15. A method according to claim 14, wherein the speaker mounting portion includes a bore and the snap-in connectors each includes a snap-in post, wherein separating the interchangeable end portion from the speaker mounting portion includes withdrawing the post of the interchangeable end portion's snap-in connector from the bore, and wherein releasably mounting the replacement interchangeable end portion includes snapping the post of the replacement interchangeable end portion into the bore.

16. An earpiece comprising:
an elongated ear hook configured to be mounted over a user's ear;
a speaker mounted to the ear hook and being adapted to generate audible signals based on electrical signals received from an electronic device; and
a wire connected to the speaker for electrically coupling the speaker to the electronic device;
the ear hook having an elongated slot along a portion thereof, the slot being configured to releasably retain the wire therein so as to support the wire on the ear hook.

17. An earpiece according to claim 16, wherein the slot is defined along an end portion of the ear hook.

18. An earpiece according to claim 17, wherein the end portion comprises a flexible material, the flexible material defining a wall portion spaced from a main portion of the end portion to define the slot.

19. An earpiece according to claim 18, wherein the wall portion resiliently flexes inwardly to retain the wire in the slot.

20. An earpiece according to claim 16, wherein the slot is defined by resilient structure that releasably retains the wire in the slot and flexes to enable the wire to be removed from the slot.

21. An earpiece according to claim 16, wherein the slot is a first slot and the ear hook has a second elongated slot along another portion thereof in spaced relation from the first slot, the slots being configured to releasably retain the wire therein so as to support the wire on the ear hook.

22. An earpiece according to claim 21, wherein the first slot is defined along a lower end portion of the ear hook arranged to be positioned adjacent a lower part of a wearer's ear, and wherein the second slot is defined along an upper portion of the ear hook arranged to be positioned adjacent an upper part of the wearer's ear, thus enabling the slots to guide the wire along the ear hook behind the wearer's ear.

23. An earpiece according to claim 22, wherein the second slot is defined on an uppermost portion of the ear hook.
